(19) United States
(12) Patent Application Publication
(10) Pub. No.: US 2018/0154831 A1
(43) Pub. Date: Jun. 7, 2018

(54) COMPOSITE DISPLAY FROM ONE OR MORE CAMERAS

(71) Applicant: Faraday&Future Inc., Gardena, CA (US)

(72) Inventors: Charles Edward Spencer, Long Beach, CA (US); Marcos A. Robles, Long Beach, CA (US); Arees Kumar Uthayasurian, Huntington Beach, CA (US); Hong S. Bae, Torrance, CA (US); Oliver Max Jeromin, Torrance, CA (US)

(21) Appl. No.: 15/662,660

(22) Filed: Jul. 28, 2017

Related U.S. Application Data
(60) Provisional application No. 62/368,689, filed on Jul. 29, 2016.

(51) Int. Cl. B60R 1/00; H04N 5/232; H04N 5/247; H04N 5/262; H04N 5/265

(52) U.S. Cl. CPC B60R 1/00; H04N 5/23293; H04N 5/247; H04N 5/2628; H04N 5/265; B60R 2300/306; B60R 2300/303; B60R 2300/802; B60R 2300/8093; B60R 2300/8046; B60R 2300/105

(57) ABSTRACT

Displays for a vehicle can be used to display a composite feed from one or more cameras. In some examples, the vehicle display can be a rear-view mirror replacement display. In some examples, the vehicle can include feeds from a rear-view camera and two side-view cameras. The composite feed for the display can be adapted according to monitored conditions. For example, when a vehicle is detected in a blind spot, the composite feed can be adapted to add a feed from the corresponding side view camera. In some examples, when a vehicle is detected in the blind spot, the composite feed can be adapted to increase the proportion of the display area allocated to the side-view camera feed from the corresponding side-view camera. In some examples, when a vehicle is detected in the blind spot, the corresponding side-view camera view can be visually distinguished.

### CROSS-REFERENCE TO RELATED APPLICATIONS

This application claims the benefit of U.S. Provisional Application No. 62/368,689, filed Jul. 29, 2016, the entirety of which is hereby incorporated by reference.

### FIELD OF THE DISCLOSURE

This relates generally to displays, and more particularly, to vehicle displays including composite image/video feeds from one or more cameras.

### BACKGROUND OF THE INVENTION

Many vehicles, especially automobiles, provide one or more exterior side-view mirrors and/or interior rear-view mirrors to aid drivers. Side mirrors, for example, have become standard equipment in personal automobiles, and side mirrors are useful for checking for vehicles in the adjacent lanes before making lane changes. Exterior side-view mirrors, however, by virtue of protruding from the body of vehicle, can contribute to aerodynamic drag of the vehicle. Additionally, existing exterior and interior mirror configurations can include blind spots and can divert a driver's concentration from the road ahead.

### SUMMARY OF THE DISCLOSURE

This relates to composite feeds for displays for a vehicle including one or more mirror replacement cameras. Interior and/or exterior mirrors can be augmented with or replaced by systems including one or more cameras and one or more displays. In some examples, exterior side mirrors can be augmented with or replaced by one or more cameras configured to capture the same or a similar general field of view as conventional side-view mirrors. The side views captured by the one or more cameras can be displayed on one or more displays in the vehicle. Replacing the side-view cameras can allow for a more aerodynamic vehicle exterior. Additionally, the camera views (side and rear) can provide expanded functionality in terms of providing the driver better awareness of the vehicle's surroundings (e.g., blind spots) and different composite views under different conditions. In some examples, the side views captured by the one or more cameras can be integrated into a composite feed and displayed on one display (e.g., on a display replacing the interior rear-view mirror). Providing the side and rear views on one display in the vehicle can more quickly provide information clearly and concisely to a driver in a car-forward orientation, thereby requiring less diversion of concentration from the road ahead to acquire situational awareness.

In some examples, the vehicle display can be a rear-view mirror replacement display. In some examples, the vehicle can include feeds from a rear-view camera and two side-view cameras. The composite feed for the display can be adapted according to monitored conditions. For example, when a vehicle is detected in a blind spot, the composite feed can be adapted to add a feed from the corresponding side-view camera. In some examples, when a vehicle is detected in the blind spot, the composite feed can be adapted to increase the proportion of the display area allocated to the side-view camera feed from the corresponding side-view camera. In some examples, when a vehicle is detected in the blind spot, the corresponding side-view camera view can be visually distinguished.

### BRIEF DESCRIPTION OF THE DRAWINGS

FIG. 1 illustrates an exemplary system block diagram of a vehicle control system including one or more mirror replacement cameras and a mirror replacement display according to examples of the disclosure.

FIG. 2A illustrates a vehicle outfitted with one or more mirror replacement cameras and a mirror replacement display according to examples of the disclosure.

FIG. 2B illustrates a top view of a vehicle including with one or more mirror replacement cameras and corresponding rear views according to examples of the disclosure.

FIG. 3 illustrates a forward-facing interior view of a vehicle including one or more mirror replacement displays according to examples of the disclosure.

FIGS. 4A-4C illustrate exemplary display views of an adaptive mirror-replacement display according to examples of the disclosure.

FIGS. 5A and 5B illustrate exemplary processes of adapting a display of an adaptive mirror-replacement display according to examples of the disclosure.

FIGS. 6A and 6B illustrate two exemplary display views of a mirror-replacement display according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

This relates to composite feeds for displays for a vehicle including one or more mirror replacement cameras. Interior and/or exterior mirrors can be augmented with or replaced by systems including one or more cameras and one or more displays. In some examples, exterior side mirrors can be augmented with or replaced by one or more cameras configured to capture the same or a similar general field of view as conventional side-view mirrors. The side views captured by the one or more cameras can be displayed on one or more displays in the vehicle. Replacing the side-view cameras can allow for a more aerodynamic vehicle exterior. Additionally, the camera views (side and rear) can provide expanded functionality in terms of providing the driver better awareness of the vehicle's surroundings (e.g., blind spots) and different composite views under different conditions. In some examples, the side views captured by the one or more cameras can be integrated into a composite feed and displayed on one display (e.g., on a display replacing the interior rear-view mirror). Providing the side and rear views on one display in the vehicle can provide more quickly provide information clearly and concisely to a driver in a car-forward orientation, thereby requiring less diversion of concentration from the road ahead to acquire situational awareness.

In some examples, the vehicle display can be a rear-view mirror replacement display. In some examples, the vehicle can include feeds from a rear-view camera and two side-view cameras. The composite feed for the display can be adapted according to monitored conditions. For example, when a vehicle is detected in a blind spot, the composite feed can be adapted to add a feed from the corresponding side-view camera. In some examples, when a vehicle is detected in the blind spot, the composite feed can be adapted to increase the proportion of the display area allocated to the side-view camera feed from the corresponding side-view camera. In some examples, when a vehicle is detected in the blind spot, the corresponding side-view camera view can be visually distinguished.

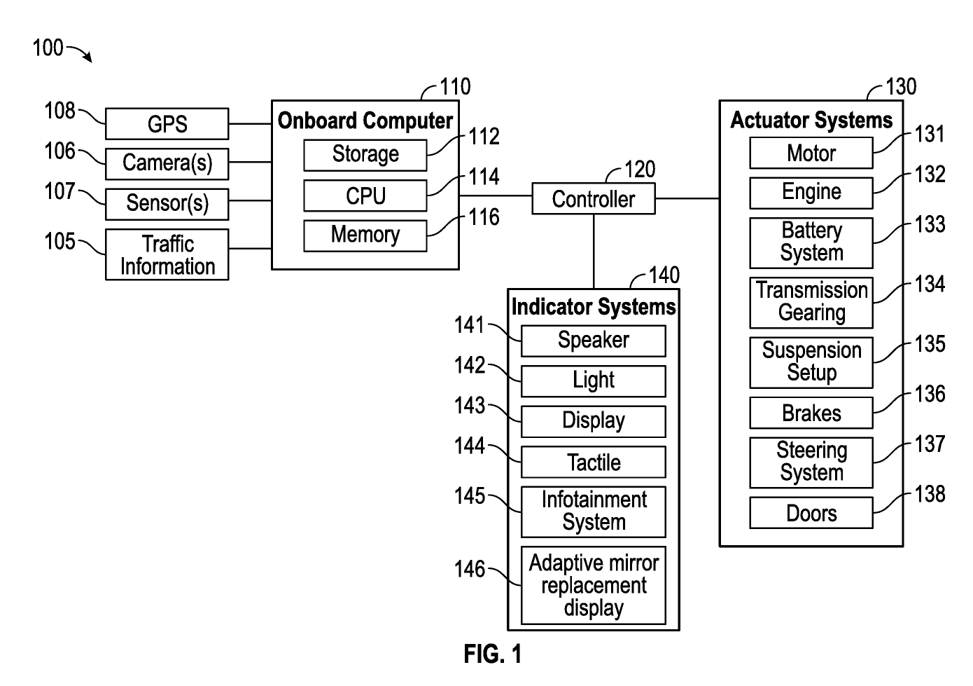

FIG. 1 illustrates an exemplary system block diagram of a vehicle control system including one or more mirror replacement cameras and an adaptive mirror replacement display according to examples of the disclosure. System 100 can be incorporated into a vehicle, such as a consumer automobile. Other example vehicles that may incorporate the system 100 include, without limitation, airplanes, boats, motorcycles or industrial automobiles. Vehicle control system 100 can include one or more cameras 106 capable of capturing image data (e.g., video data) for determining various characteristics of the vehicle's surroundings. The one or more cameras 106 can include one or more side-view mirror replacement cameras (e.g., side-mounted, rear view) and one or more mirror replacement rear-view cameras (e.g., center-mounted, rear view). Vehicle control system 100 can also include one or more other sensors 107 (e.g., radar, ultrasonic, LIDAR, etc.) capable of detecting various characteristics of the vehicle's surroundings. For example, sensors 107 can be used for detecting the presence of an object. Global Positioning System (GPS) receiver 108 capable of determining the location of the vehicle. In some examples, traffic information 105 can be received (e.g., by an antenna) or accessed (e.g., from storage 112 or memory 116), and can be used for determining automated driving routes.

Vehicle control system 100 can include an on-board computer 110 coupled to the traffic information 105, cameras 106, sensors 107, and GPS receiver 108. On-board computer 110 can be capable of receiving one or more of the traffic information, image data from the cameras, outputs from the sensors 107 and the GPS receiver 108. On-board computer 110 can include storage 112, memory 116, and a processor (central processing unit (CPU)) 114. CPU 114 can execute automated driving software stored in storage 112 and/or memory 114. For example, CPU 114 can process the traffic information, image data, sensor outputs and GPS outputs and make driving decisions thereon. For example, processing can include detecting and tracking objects in the environment, tracking vehicle parameters (e.g., odometry, location), navigation planning, lane selection/change planning, motion planning, determining automated driving commands, etc. CPU 114 (or another processor in vehicle 100) can also process input from the one or more cameras 106 to generate a composite feed for a display or otherwise adjust the display for an adaptive display, as discussed in more detail herein. Additionally, storage 112 and/or memory 116 can store data and instructions for performing the above processing. Storage 112 and/or memory 116 can be any non-transitory computer readable storage medium, such as a solid-state drive, a hard disk drive or a random access memory (RAM) among other possibilities.

The vehicle control system 100 can also include a controller 120 capable of controlling one or more aspects of vehicle operation based on automated driving commands received from the processor. In some examples, the vehicle control system 100 can be connected to (e.g., via controller 120) one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137, and door system 138. The vehicle control system 100 can control, via controller 120, one or more of these actuator systems 130 during vehicle operation; for example, to open or close one or more of the doors of the vehicle using the door actuator system 138, to control the vehicle during autonomous driving or parking operations using the motor 131 or engine 132, battery system 133, transmission gearing 134, suspension setup 135, brakes 136 and/or steering system 137, etc. It should be understood that autonomous driving described herein is not limited to fully autonomous driving systems; autonomous driving can include fully or partially autonomous driving, and/or driver assistance systems.

The one or more indicator systems 140 can include, but are not limited to, one or more speakers 141, one or more lights 142 in the vehicle, one or more displays 143 in the vehicle, one or more tactile actuators 144 in the vehicle (e.g., as part of a steering wheel or seat in the vehicle), one or more infotainment systems 145 (e.g., providing entertainment and/or information to the user), and/or one or more mirror-replacement adaptive displays 146. As described herein, the one or more mirror replacement adaptive displays 146 can adaptively display views (e.g., a composite feed) based on input (e.g., feeds) from one or more cameras 106. The vehicle control system 100 can control, via controller 120, one or more of these indicator systems 140 to provide indications to a user of the vehicle.

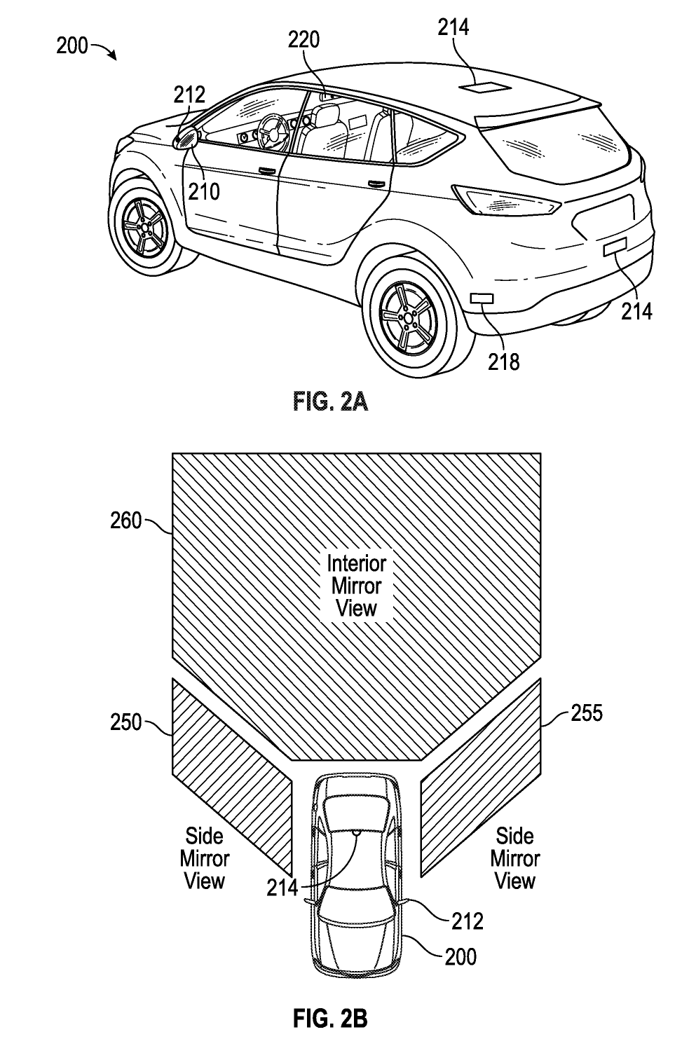

As described herein, a vehicle can be equipped with one or more mirror replacement cameras and one or more displays (e.g. adaptive displays). FIG. 2A illustrates a vehicle outfitted with one or more mirror replacement cameras and a mirror replacement display according to examples of the disclosure. Vehicle 200 can include one or more side-view mirror replacement cameras 212 (also referred to herein as side-view cameras) and one or more rear view replacement cameras 214 (also referred to herein as rear-view cameras). The one or more side-view mirror replacement cameras 212 can include a right-side side-view camera and a left-side side-view camera. The cameras can be configured to capture the same or a similar general field of view as the conventional side-view and rear-view mirrors. In some examples, a rear view replacement camera 214 can be mounted (e.g., center-mounted) on or in the top of the vehicle (e.g., roof, spoiler, etc.). In some examples, a rear view replacement camera 214 can be mounted on or in the rear of the vehicle (e.g., on a lift gate, lift gate spoiler, bumper, etc.). In some examples, the rear view replacement camera can be on the interior of vehicle 200. In some examples, the side-view mirror replacement cameras 212 can be mounted on or in a side of the vehicle (e.g., door or other side surface of the vehicle frame). In some examples, the side-view mirror replacement cameras 212 can be mounted on a structure protruding from the vehicle 200 body. Although referred to herein as mirror replacement cameras, in some examples, the side-view mirror replacement cameras 212 can be mounted on or in side-view mirrors 210. Vehicle 200 can also include one or more displays. The displays can display a feed from one or more mirror-replacement cameras, as described herein. In some examples, the displays can be fixed displays configured to display composite feeds from the one or more cameras. In some examples, the display can be adaptive displays. In some example, adaptive display 220 can replace the conventional rear-view mirror in the interior of the vehicle. Although illustrated as replacing a conventional rear-view mirror, one or more adaptive displays can have a different size and/or shape than conventional rear-view mirrors. Additionally, the adaptive rear view display can be located differently in vehicle 200. For example, the one or more adaptive displays can be part of a heads-up display projected on the vehicle windshield, part of a vehicle dash, or part of a vehicle console. The one or more displays can display information from one or more of the mirror replacement cameras.

FIG. 2B illustrates a top view of a vehicle including with one or more mirror replacement cameras and corresponding rear views according to examples of the disclosure. As described with reference to FIG. 2A, vehicle 200 can include one or more side-view cameras 212 and one or more rear-view cameras 214. As illustrated in FIG. 2B, vehicle 200 can include, for example, left and right side-view cameras 212 and a center-mounted rear-view camera 214. Side-view cameras 212 can capture the side mirror views 250 and 255, including left and right blind spots, respectively. Rear-view camera 214 can capture a rear mirror view 260 similar to what a conventional interior mirror would capture. Although the side mirror views 250 and 255 illustrated in FIG. 2B show the blind spots on the side of the car, it should be understood that the sides view cameras 212 can also capture further side portions of the rear view that can be captured in rear mirror view 260. In other words, side mirror views 250 and 255 can extend beyond the area illustrated in FIG. 2B into portions of the rear mirror view 260. Although illustrated in FIG. 2B as being mounted on a side-view mirror, as described above with respect to FIG. 2A, side-view cameras 212 need not be mounted on side-view mirrors (and the vehicle may not even include side-view mirrors to reduce aerodynamic drag). Additionally, although illustrated in FIG. 2B as being mounted on the roof, as described above with respect to FIG. 2A, the rear-view camera 214 can be mounted on a top or rear surface other than the roof (e.g., bumper, lift gate spoiler, etc.).

Referring back to FIG. 2A, vehicle 200 can also include one or more blind spot monitoring (BSM) sensors 218. The BSM sensors 218 can detect an object (e.g., a vehicle) located in the blind spot. The detection of an object in the blind spot can trigger an adaptation in the display of camera view information on adaptive display 220, as described in more detail below. In some examples, a BSM sensor can be located proximate to the blind spots of the car (e.g., near rear corners of vehicle 200). The BSM sensors can be based on ultrasonic sensors, radar, LIDAR, and/or cameras (with image processing).

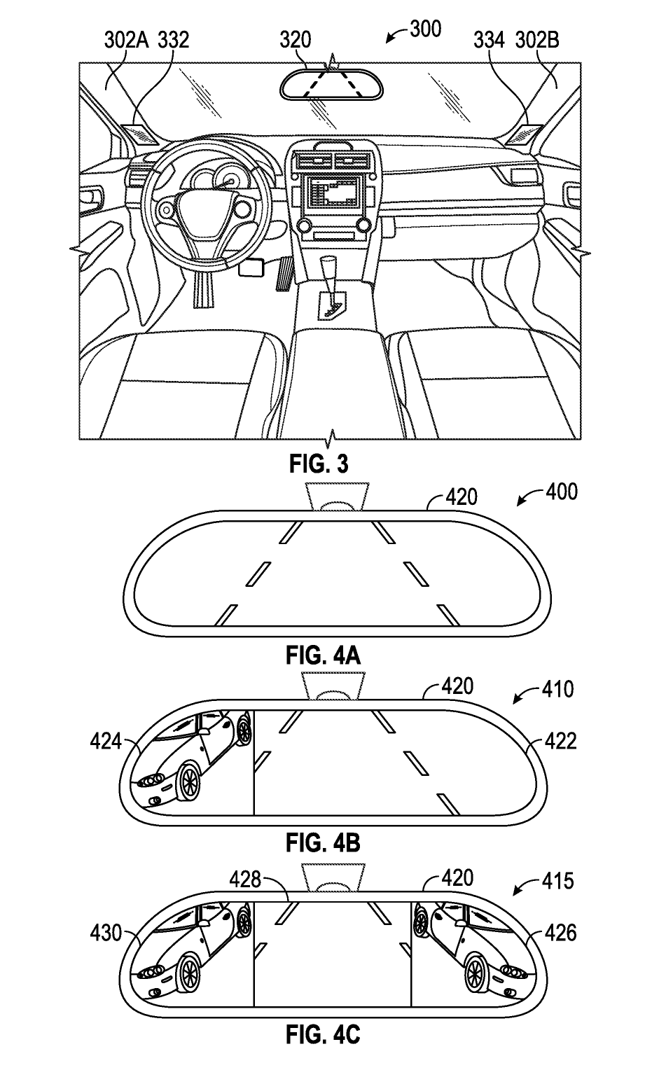

FIG. 3 illustrates a forward-facing interior view of a vehicle including one or more mirror replacement displays according to examples of the disclosure. The information (e.g., image/video feeds) captured from the side-view and/or rear-view mirror replacement cameras can be processed into a composite feed displayed on one or more displays (e.g., adaptive displays) in vehicle 300. In some examples, vehicle 300 can include side/rear view displays 332 and 334 proximate to the location of a conventional side-view mirror, but in the interior of the car. For example, side/rear view displays 332 and 334 can be integrated with A-pillars 302A and 302B. Such a placement can be familiar to drivers accustomed to vehicles with conventional mirrors, but require less diversion of attention from the road than conventional side-view mirrors. Side/rear view displays 332 and 334 can display views corresponding to side mirror views 255 and 250, respectively. In some examples, side/rear view displays 332 and 334 can display views corresponding to rear mirror view 260 in addition to or instead of side mirror views 250 and 255. In some examples, vehicle 300 can include a rear-view mirror display 320 (corresponding to adaptive display 220 in FIG. 2A). It should be understood that the rear-view mirror display can be a display positioned in the vehicle proximate to the location of a conventional rear-view mirror in a vehicle, and the rear-view mirror display may not include a mirror at all. In some example, rear-view mirror display 320 can display views corresponding to rear mirror view 260. In some examples, rear-view mirror display 320 can be adapted to display rear mirror view 260 and/or one or more side mirror views 250 and 255 depending on the conditions. In some examples, the camera feeds can be further processed, as discussed herein, when multiple camera feeds are integrated into a composite feed displayed on one display device. Although FIG. 3 illustrates three displays, it is understood that a vehicle can include fewer or more displays, and one or more of the displays can be adaptive displays.

In some examples, side/rear displays 332 and 334 can be active at all times (e.g., true side-view mirror replacements). In some examples, side/rear displays 332 and 334 can be active under some conditions when side views can be more useful to a driver (e.g., when the vehicle is moving, when lane change signals are activated, when lane changes are detected, when a vehicle appears in a blind spot, etc.) and disabled under other conditions when side views can be less useful and/or more distracting to a driver (e.g., when the vehicle is parked, when no lane changes are planned or occur, in an autonomous driving mode). In some examples, side/rear displays 332 and 334 can be disabled when information from side-view cameras is displayed on another display (e.g., on rear-view mirror display 320).

Rear-view mirror display 320 (also referred to herein as a rear view display) can be active at all times (e.g., true rear-view mirror replacement). In some examples, rear-view mirror display 320 can be active under some conditions when side and/or rear views can be more useful to a driver (e.g., when the vehicle is moving, when lane change signals are activated, when lane changes are detected, when a vehicle appears in a blind spot, etc.) and disabled under other conditions when side views can be less useful and/or more distracting to a driver (e.g., when the vehicle is parked, when no lane changes are planned or occur, in an autonomous driving mode).

FIGS. 4A-4C illustrate exemplary display views of an adaptive mirror-replacement display according to examples of the disclosure. View 400 in FIG. 4A can correspond to a default rear view. Rear-view mirror display 420 can display a rear view from a rear-view camera. View 410 in FIG. 4B can correspond to an adapted view when a vehicle is located in a left side blind spot. In view 410, rear-view mirror display 420 can display a first image 422 corresponding to the rear view from a rear-view camera and display a second image 424 corresponding to the left-side blind spot (showing the vehicle in the left-side blind spot). View 415 in FIG. 4C can correspond to an adapted view when a vehicle is located in a left side blind spot and a right hand blind spot. In view 415, rear-view mirror display 420 can display a first image 428 corresponding to the rear view from a rear-view camera, display a second image 426 corresponding to the right-side blind spot (showing the vehicle in the right-side blind spot) and display a third image 430 corresponding to the left-side blind spot (showing the vehicle in the left-side blind spot).

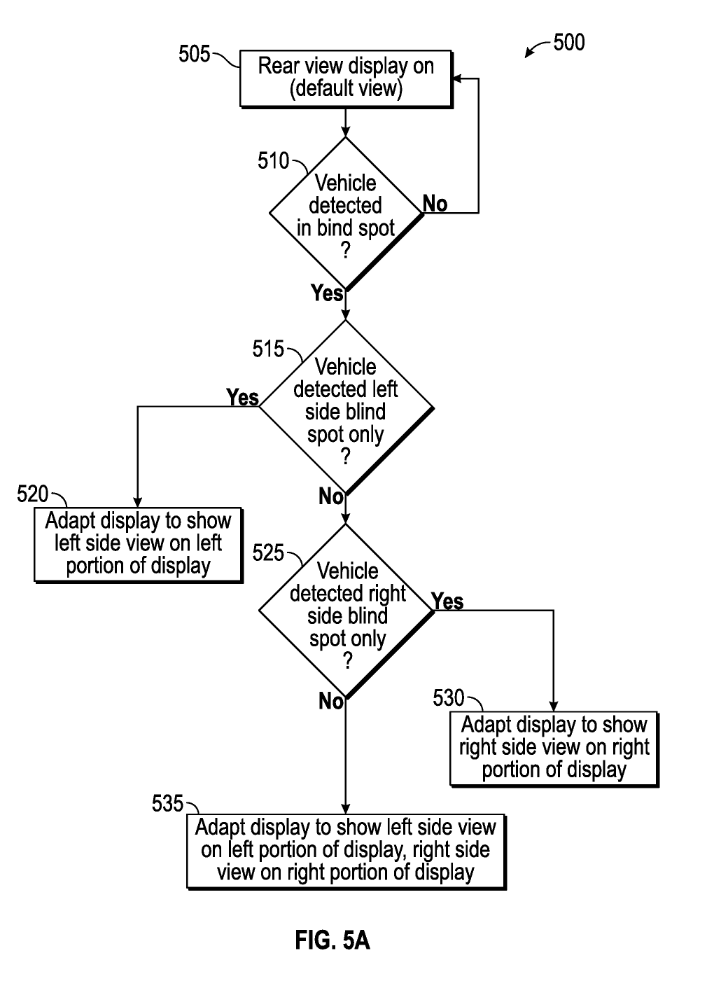

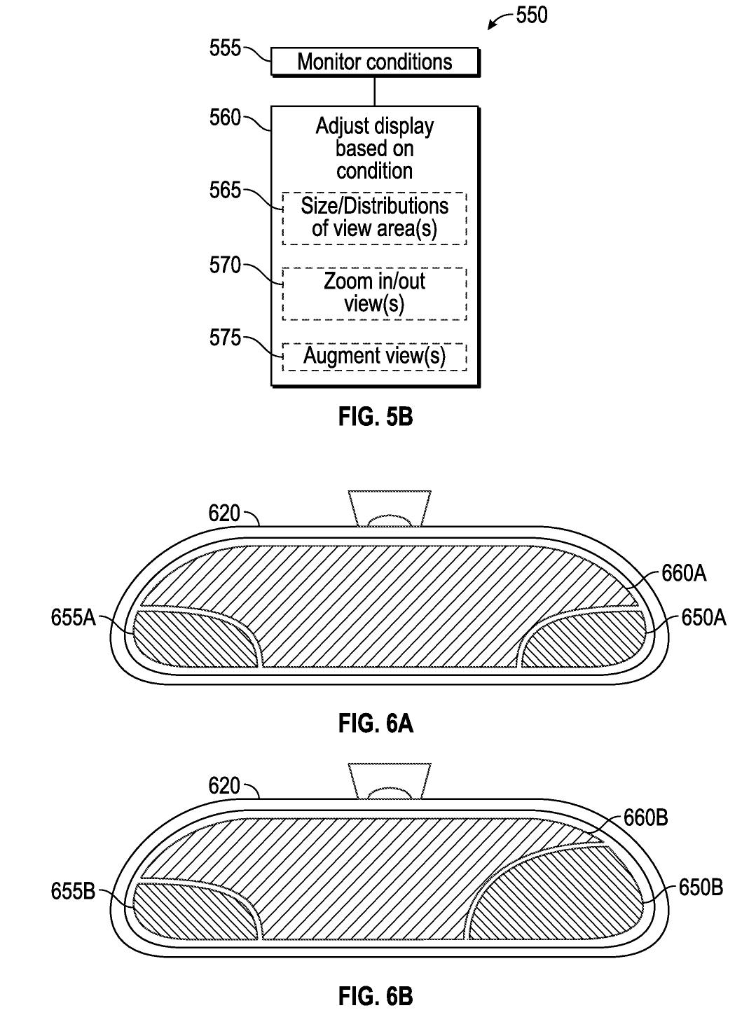

FIGS. 5A and 5B illustrate exemplary processes of adapting a display of an adaptive mirror-replacement display according to examples of the disclosure. FIG. 5A illustrates an exemplary process 500 of adapting a display (composite feed) of an adaptive mirror-replacement display based on blind-spot monitoring according to examples of the disclosure. At 505, the rear-view mirror display (e.g., corresponding to rear-view mirror display 220, 320, 420) can be turned on (e.g., when the vehicle power turns on). The view displayed on the rear-view mirror display can be a default view. The default view can correspond to the rear view (e.g., as illustrated in FIG. 4A) from one or more rear-view cameras (e.g., camera 214). At 510, a blind spot monitoring system can detect whether there are objects (e.g., other vehicles) in the blind spots of the vehicle. The blind spot monitoring can be based on analysis of images/video from side-view cameras, such as side-view cameras 212, or from BSM sensors 218. When no vehicles are detected in the blind spots, the rear-view mirror display can continue to display the default view. When one or more vehicles are detected in blind spots, the display of the rear-view mirror display can be adapted to display a composite feed including feeds from one or more side-view cameras. At 515, the system can determine whether the vehicle is detected in a left-side blind spot on the left side. When the vehicle is detected in the left-side blind spot, at 520 the display can be adapted to show images/video of the blind spot on a left hand portion of the rear-view mirror display (e.g., as illustrated in FIG. 4B). The right hand portion of the rear-view mirror display can continue to display the remaining portion of the rear view. In some examples, the right hand portion of the display can display the full rear view, zoomed out so it can be fit in the right hand portion of the display without obscuring the rear view. At 525, the system can determine whether the vehicle is detected in a blind spot on the right side. When the vehicle is detected in the right-side blind spot, at 530 the display can be adapted to show images/video of the right-side blind spot on a right hand portion of the rear-view mirror display. The left hand portion of the rear-view mirror display can continue to display the remaining portion of the rear view. In some examples, the left hand portion of the display can display the full rear view, zoomed out so it can be fit in the left hand portion of the display without obscuring the rear view. When vehicles are detected in both the left-side and right-side blind spots, at 535 the display can be adapted to show images/video of the right-side blind spot on a right hand portion of the rear-view mirror display and show images/video of the left-side blind spot on a left hand portion of the rear-view mirror (as illustrated in FIG. 4C). The center portion of the rear-view mirror display can continue to display the remaining portion of the rear view. In some examples, the center portion of the display can display the full rear view, zoomed out so it can be fit in the center portion of the display without obscuring the rear view.

Although described in process 500 as adapting the display based on blind spot monitoring, in some examples, activating a turn indicator can be used to adapt the display. For example, activating the left-hand turn indicator can cause the display to be adapted as illustrated in FIG. 4B. Likewise, activating the right-hand turn indicator can cause the display to be adapted to display the right-side blind spot. In some examples, the turn indicator can be used to simplify the adaptation when using blind spot monitoring. For example, even when there are vehicles in both blind spots as detected by BSM sensors 218, when a turn indicator is on, only that blind spot of the side corresponding to the turn indicator is displayed.

Although process 500 describes adapting a rear view display based on blind spot monitoring, the adaptation of the display is not so limited. FIG. 5B illustrates an exemplary process 550 of adapting a display of an adaptive mirror-replacement display based on monitoring various conditions according to examples of the disclosure. At 555, various conditions can be monitored. The conditions can include a mode of operation (e.g., autonomous driving mode, driving assist mode, parking assist mode, non-autonomous mode), transmission states (e.g., park, reverse, drive, etc.), vehicle parameters (e.g., vehicle speed, turn signal switch states), environmental conditions (e.g., traffic conditions, vehicle navigation). At 560, based on the monitored conditions, views (composite feeds) of one or more displays can be adjusted. In some examples, the adjustment can include changing the distribution of view area allotted for input feeds from each camera (565). For example, as described above in FIG. 4A-4C and process 5A, a default view can allot 100% of the rear view display 420 to the rear-view camera, but blind spot monitoring can cause the allotment of some portion of the display to side-view cameras. For example, when a vehicle is in a blind spot on one side, some percentage of the display (e.g., 25-50%) can be allocated to the side view and the remaining portion of the display can be allocated to the rear view. When a vehicle is in each of the blind spots, some percentage of the display (e.g., 25%-33.33%) can be allocated to each of the two side views and the remaining portion of the display can be allocated to the rear view. In some examples, the adjustment can include panning or zooming the input from one or more cameras for the display in the respective view area (570). For example, when a turn indicator is on, the input from the side-view camera corresponding to the side of the turn indicator can be zoomed in to increase the size of the vehicle in the blind spot to focus a driver's attention on the vehicle itself. In some examples, when in reverse and driving at a low speed, the side view can be panned such that the view can include lower features in the view such as curbs or parking lines. In some examples, the adjustment can include augmenting (e.g., highlighting or providing some other visual indicator) one or more views (575). For example, when a vehicle is in the blind spot, a view corresponding to the blind spot can be adjusted to highlight the view. In some examples, the lighting intensity of the side view can be increased (and/or other views can be dimmed). In some examples, the side view can be tinted with a color indicative of a vehicle in the blind spot (e.g., red or amber). In some examples, a light around and/or proximate to the side view can be activated.

In some examples, a default rear view display can include rear and side views. Including rear and side views on the display can provide information clearly and concisely in one place to more quickly provide improved situation awareness to drivers. The rear-view mirror can provide one broad image which provides situational awareness about objects and depth (e.g., vehicles behind the host vehicle and their perceived distance). Side views can provide information about vehicles in that may be present in blind spots.

In some examples, the rear and side views can be distributed side by side in the display (e.g., for example, as illustrated in FIG. 4C.) The division of the display area between different views in the default display setting can be such that the display area can be divided evenly (e.g., ⅓ each for each of the three views) or in different proportions (e.g., 25% for each side and 50% for the rear view) between the camera feeds.

FIGS. 6A and 6B illustrate two exemplary display views of a mirror-replacement display according to examples of the disclosure. FIG. 6A illustrates an exemplary default view of the display including rear and side views according to examples of the disclosure. As discussed herein, the interior center rear-view mirror can be replaced by a display showing images/video feeds captured. A processor (e.g., CPU 114 or another processor) can combine multiple real-time feeds from each camera (e.g., rear-view camera 214 and side-view cameras 212) and display a composite feed on a single rear-view mirror replacement display. In FIG. 6A, rear view display 620 can include three display areas corresponding to the three camera feeds. For example, display area 660A can corresponding to the interior mirror view 260 of rear-view camera 214, display area 650A can correspond to the right side mirror view 250 of right side-view camera 212 and display area 655A can correspond to the left side mirror view 255 of left side-view camera 212. The feed from the center camera can occupy a larger portion of the display area than each of the side cameras to provide sufficient rear view (e.g., in a default state for an adaptive display). The left and right views can each take up less than ⅓ of the display area in the default state, for example. For example, display area 660A can occupy approximately 50% of the total display area, and each of display areas 650A and 655A can occupy approximately 25% of the total display area.

In some examples, display areas 650A and 655A can be disposed such that a portion of display area 660A can extend across the horizontal axis of the rear view display 620. For example, as illustrated in FIG. 6A display area 660A can extend across the top of the rear view display 620 along the horizontal axis. In such a configuration, the horizon portion of the rear view can be uninterrupted and provide important situational awareness to the driver. Display areas 650A and 655A can be placed in the lower right and left corners, and can obscure portions of the rear view from the center, rear-view camera that typically can be less important (e.g., fast moving road) and can be more duplicative of information captured by the side views and remaining rear view.

The composite display can be adjusted dynamically to allocate more (or less) of the displaying area to one or more of the camera feeds. For example, when the vehicle is making a left turn or moving into a left lane, the feed from the left camera can take up a larger display area than during normal driving. Similarly, when the vehicle is making a right turn or moving into a right lane, the feed from the right camera can take up a larger display area. FIG. 6B illustrates an exemplary view of the adaptive display when making a right turn or lane change according to examples of the disclosure. As illustrated in FIG. 6B, display area 650B corresponding to the right side view can be increased to occupy more of the display area. The display area 660B can be decreased and/or display area 655B can be decreased. In some examples, only display area 66B can be decreased. Similarly, if another vehicle is in the right blind spot of the vehicle, the feed from the right-side camera can take up more display area. Additionally or alternatively, the feed for the relevant blind spot (left or right) can flash/change color (or otherwise visual distinguish the view) when a vehicle is in the blind spot. In some examples, when the vehicle is in reverse, the feed from the center camera can take up most or all of the display area. Additionally, when in reverse or when parking, the view provided on one or more of the display areas can be panned downward (i.e., the view can show more of the lower portion of the respective view than shown in the default view) to shown curbs or parking lines. In some examples, the images in one or more display areas can be zoomed in when driving at low speeds and zoomed out when driving faster (i.e., zoomed out when information from a broader field of view can be more useful).

The processor can determine whether the vehicle is moving into a different lane, making a turn, backing up, parking, or any other condition or state based on information including, but not limited to, steering angle, turning signal, the selected gear, and data detected by exterior cameras and/or ultrasonic sensors.

In some examples, when driving in an autonomous driving mode, the adaptive display can show only (or primarily) the rear view, but when transitioning control to the driver, the display can be adapted. When the transition occurs, blind spot views can be presented and/or be allocated more of the display area to provide situational awareness than may be important.

It should be understood that adaptive displays can also become a distraction for drivers if the display changes too dynamically. In some examples, the types of changes of the adaptive display can be limited (e.g., by a rate of change and/or a number of changes). For example, if vehicles enter the left and right blind spots at the same time, rather than adapting the display to increase the display area of both blind spot images, only one display area is increased or added (e.g., based on turn indicator or direction of steering, etc.)

In some examples, the display can be adapted manually by the driver to allow for improved customization. In particular, different users may want to allocate display area to different camera feeds in a unique way. In some examples, the amount of customization may be limited to maintain minimum required views. For example, each view may require a minimum threshold area of the display area (e.g., 20% for side views, 33% for center view). In some examples, each view may have a maximum threshold area of display area (e.g., 33% for side views, 60% for center view).

Therefore, according to the above, some examples of the disclosure are directed to a vehicle. The vehicle can comprise a plurality of cameras, a display, and a processor coupled to the plurality of cameras and the display. The processor can be configured to display, on the display, a composite feed based on input feeds from the plurality of cameras. The processor can allocate a first area of the display to a first input feed of a first camera of the plurality of cameras, can allocate a second area of the display to a second input feed of a second camera of the plurality of cameras, and can allocate a third area of the display to a third input feed of a third camera of the plurality of cameras. The first area can be different than the second area or the third area. Additionally or alternatively to one or more of the examples disclosed above, in some examples, the first camera can comprise a rear-view camera, the second camera can comprise a first side-view camera, and the third camera can comprise a second side-view camera. Additionally or alternatively to one or more of the examples disclosed above, in some examples, the first area can comprise more than a third of the display area and the second area and the third area can each comprise less than a third of the display area. Additionally or alternatively to one or more of the examples disclosed above, in some examples, the processor can be further configured to: in response to detecting a second vehicle in a first blind spot corresponding to a first side of the vehicle, increase the second area allocated to the second input feed of the second camera corresponding to the first side-view camera and decrease at least one of the first area or the third area; and in response to detecting the second vehicle in a second blind spot corresponding to a second side of the vehicle, increase the third area allocated to the third input feed of the third camera corresponding to the second side-view camera and decrease at least one of the first area or the second area. Additionally or alternatively to one or more of the examples disclosed above, in some examples, the processor can be further configured to: in response to detecting an activation of a turn signal corresponding to a first side of the vehicle, increase the second area allocated to the second input feed of the second camera corresponding to the first side-view camera and decrease at least one of the first area or the third area; and in response to detecting an activation of the turn signal corresponding to a second side of the vehicle, increase the third area allocated to the third input feed of the third camera corresponding to the second side-view camera and decrease at least one of the first area or the second area. Additionally or alternatively to one or more of the examples disclosed above, in some examples, the processor can be further configured to: in response to detecting a second vehicle in a first blind spot corresponding to a first side of the vehicle, visually distinguish the second input feed of the second camera corresponding to the first side-view camera; and in response to detecting the second vehicle in a second blind spot corresponding to a second side of the vehicle, visually distinguish the third input feed of the third camera corresponding to the second side-view camera. Additionally or alternatively to one or more of the examples disclosed above, in some examples, the processor can be further configured to: zoom in or out at least one of the input feeds to display in a corresponding display area. Additionally or alternatively to one or more of the examples disclosed above, in some examples, the processor can be further configured to: pan at least one of the input feeds to display in a corresponding display area. Additionally or alternatively to one or more of the examples disclosed above, in some examples, the display can comprise a rear-view mirror replacement display.

Some examples of the disclosure are directed to a vehicle. The vehicle can comprise a plurality of cameras, a display, and a processor coupled to the plurality of cameras and the display. The processor can be configured to: in a first state, display, on the display, a first feed based on one or more first cameras of the plurality of cameras; and in a second state, display, on the display, a second feed based on one or more second cameras of the plurality of cameras. A first allocation of display area to the one or more first cameras can be different than a second allocation of the display area to the one or more second cameras. Additionally or alternatively to one or more of the examples disclosed above, in some examples, the first state can comprise an autonomous driving state and the first feed can comprise an input feed from one rear-view camera. The second state can comprise a non-autonomous driving state and the second feed can comprise input feeds from the one rear-view camera and at least one side-view camera. Additionally or alternatively to one or more of the examples disclosed above, in some examples, the first state can comprise a blind spot empty state and the first feed can comprise an input feed from one rear-view camera. The second state can comprise a blind spot occupied state and the second feed can comprise input feeds from the one rear-view camera and at least one side-view camera. Additionally or alternatively to one or more of the examples disclosed above, in some examples, the first state can comprise a blind spot empty state and the first feed can comprise input feeds from one rear-view camera and two side-view cameras. The second state can comprise a blind spot occupied state and the second feed can comprise input feeds from the one rear-view camera and the two side-view camera. At least one side-view camera can be allocated a larger percentage of display area in the second state than can be allocated to the at least one side-view camera in the first state. Additionally or alternatively to one or more of the examples disclosed above, in some examples, the first state can comprise a turn indicator deactivated state and the first feed can comprise an input feed from one rear-view camera. The second state can comprise a turn indicator activated state and the second feed can comprise input feeds from the one rear-view camera and one side-view camera corresponding to a side indicated by the turn indicator. Additionally or alternatively to one or more of the examples disclosed above, in some examples, the first state can comprise a turn indicator deactivated state and the first feed can comprise input feeds from one rear-view camera and two side-view cameras. The second state can comprise a turn signal activated state and the second feed can comprise input feeds from the one rear-view camera and the two side-view camera. At least one side-view camera can be allocated a larger percentage of display area in the second state than can be allocated to the at least one side-view camera in the first state. Additionally or alternatively to one or more of the examples disclosed above, in some examples, the first state can comprise a forward drive state and the first feed can comprise input feeds from one rear-view camera and two side-view cameras. The second state can comprise a reverse drive state and the second feed can comprise input feeds from the one rear-view camera and the two side-view camera. The at least one input feed from one of the two side-view cameras can be zoomed in and panned down in the second state as compared with the first state. Additionally or alternatively to one or more of the examples disclosed above, in some examples, the first state can comprise a low-speed state and the first feed can comprise an input feed from at least one rear-view camera. The second state can comprise a high-speed state and the second feed can comprise an input feed from the one rear-view camera. The input feed from the at least one rear-view cameras can be zoomed in in the first state as compared with the second state.

Some examples of the disclosure are directed to a method. The method can comprise: receiving input feeds from the plurality of cameras; and displaying, on a display in a vehicle interior, a composite feed based on the input feeds. A first area of the display can be allocated to a first input feed of a first camera of the plurality of cameras, a second area of the display can be allocated to a second input feed of a second camera of the plurality of cameras, and a third area of the display can be allocated to a third input feed of a third camera of the plurality of cameras. The first area can be different than the second area or the third area. Additionally or alternatively to one or more of the examples disclosed above, in some examples, the first camera can comprise a rear-view camera, the second camera can comprise a first side-view camera, and the third camera can comprise a second side-view camera. Additionally or alternatively to one or more of the examples disclosed above, in some examples, the first area can comprise more than a third of the display area and the second area and the third area can each comprise less than a third of the display area. Additionally or alternatively to one or more of the examples disclosed above, in some examples, the method can further comprise: in response to detecting a second vehicle in a first blind spot corresponding to a first side of the vehicle, increasing the second area allocated to the second input feed of the second camera corresponding to the first side-view camera and decreasing at least one of the first area or the third area; and in response to detecting the second vehicle in a second blind spot corresponding to a second side of the vehicle, increasing the third area allocated to the third input feed of the third camera corresponding to the second side-view camera and decreasing at least one of the first area or the second area. Additionally or alternatively to one or more of the examples disclosed above, in some examples, the method can further comprise: in response to detecting an activation of a turn signal corresponding to a first side of the vehicle, increasing the second area allocated to the second input feed of the second camera corresponding to the first side-view camera and decreasing at least one of the first area or the third area; and in response to detecting an activation of the turn signal corresponding to a second side of the vehicle, increasing the third area allocated to the third input feed of the third camera corresponding to the second side-view camera and decreasing at least one of the first area or the second area. Additionally or alternatively to one or more of the examples disclosed above, in some examples, the method can further comprise: in response to detecting a second vehicle in a first blind spot corresponding to a first side of the vehicle, visually distinguishing the second input feed of the second camera corresponding to the first side-view camera; and in response to detecting the second vehicle in a second blind spot corresponding to a second side of the vehicle, visually distinguishing the third input feed of the third camera corresponding to the second side-view camera. Additionally or alternatively to one or more of the examples disclosed above, in some examples, the method can further comprise: zooming in or out at least one of the input feeds to display in a corresponding display area. Additionally or alternatively to one or more of the examples disclosed above, in some examples, the method can further comprise: panning at least one of the input feeds to display in a corresponding display area. Additionally or alternatively to one or more of the examples disclosed above, in some examples, the display can comprise a rear-view mirror replacement display. Some examples of the disclosure are directed to a non-transitory computer-readable medium including instructions, which when executed by one or more processors, can cause the one or more processors to perform any of the above methods.

Some examples of the disclosure are directed to a method. The method can comprise: receiving input from the plurality of cameras; in a first state, displaying, on a display in a vehicle interior, a first feed based on one or more first cameras of the plurality of cameras; and in a second state, displaying, on the display, a second feed based on one or more second cameras of the plurality of cameras. A first allocation of display area to the one or more first cameras can be different than a second allocation of the display area to the one or more second cameras. Additionally or alternatively to one or more of the examples disclosed above, in some examples, the first state can comprise an autonomous driving state and the first feed can comprise an input feed from one rear-view camera. The second state can comprise a non-autonomous driving state and the second feed can comprise input feeds from the one rear-view camera and at least one side-view camera. Additionally or alternatively to one or more of the examples disclosed above, in some examples, the first state can comprise a blind spot empty state and the first feed can comprise an input feed from one rear-view camera. The second state can comprise a blind spot occupied state and the second feed can comprise input feeds from the one rear-view camera and at least one side-view camera. Additionally or alternatively to one or more of the examples disclosed above, in some examples, the first state can comprise a blind spot empty state and the first feed can comprise input feeds from one rear-view camera and two side-view cameras. The second state can comprise a blind spot occupied state and the second feed can comprise input feeds from the one rear-view camera and the two side-view camera. At least one side-view camera can be allocated a larger percentage of display area in the second state than can be allocated to the at least one side-view camera in the first state. Additionally or alternatively to one or more of the examples disclosed above, in some examples, the first state can comprise a turn indicator deactivated state and the first feed can comprise an input feed from one rear-view camera. The second state can comprise a turn indicator activated state and the second feed can comprise input feeds from the one rear-view camera and one side-view camera corresponding to a side indicated by the turn indicator. Additionally or alternatively to one or more of the examples disclosed above, in some examples, the first state can comprise a turn indicator deactivated state and the first feed can comprise input feeds from one rear-view camera and two side-view cameras. The second state can comprise a turn signal activated state and the second feed can comprise input feeds from the one rear-view camera and the two side-view camera. At least one side-view camera can be allocated a larger percentage of display area in the second state than can be allocated to the at least one side-view camera in the first state. Additionally or alternatively to one or more of the examples disclosed above, in some examples, the first state can comprise a forward drive state and the first feed can comprise input feeds from one rear-view camera and two side-view cameras. The second state can comprise a reverse drive state and the second feed can comprise input feeds from the one rear-view camera and the two side-view camera. The at least one input feed from one of the two side-view cameras can be zoomed in and panned down in the second state as compared with the first state. Additionally or alternatively to one or more of the examples disclosed above, in some examples, the first state can comprise a low-speed state and the first feed can comprise an input feed from at least one rear-view camera. The second state can comprise a high-speed state and the second feed can comprise an input feed from the one rear-view camera. The input feed from the at least one rear-view cameras can be zoomed in in the first state as compared with the second state. Additionally or alternatively to one or more of the examples disclosed above, in some examples, the display can comprise a rear-view mirror replacement display. Some examples of the disclosure are directed to a non-transitory computer-readable medium including instructions, which when executed by one or more processors, can cause the one or more processors to perform any of the above methods.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A vehicle comprising:
a plurality of cameras;
a display; and
a processor coupled to the plurality of cameras and the display, the processor configured to display, on the display, a composite feed based on input feeds from the plurality of cameras;
wherein the processor allocates a first area of the display to a first input feed of a first camera of the plurality of cameras, allocates a second area of the display to a second input feed of a second camera of the plurality of cameras, and allocates a third area of the display to a third input feed of a third camera of the plurality of cameras; and
wherein the first area is different than the second area or the third area.

2. The vehicle of claim 1, wherein the first camera comprises a rear-view camera, the second camera comprises a first side-view camera, and the third camera comprises a second side-view camera.

3. The vehicle of claim 2, wherein the first area comprises more than a third of the display area and wherein the second area and the third area each comprises less than a third of the display area.

4. The vehicle of claim 2, the processor further configured to:
in response to detecting a second vehicle in a first blind spot corresponding to a first side of the vehicle, increase the second area allocated to the second input feed of the second camera corresponding to the first side-view camera and decrease at least one of the first area or the third area; and
in response to detecting the second vehicle in a second blind spot corresponding to a second side of the vehicle, increase the third area allocated to the third input feed of the third camera corresponding to the second side-view camera and decrease at least one of the first area or the second area.

5. The vehicle of claim 2, the processor further configured to:
in response to detecting an activation of a turn signal corresponding to a first side of the vehicle, increase the second area allocated to the second input feed of the second camera corresponding to the first side-view camera and decrease at least one of the first area or the third area; and
in response to detecting an activation of the turn signal corresponding to a second side of the vehicle, increase the third area allocated to the third input feed of the third camera corresponding to the second side-view camera and decrease at least one of the first area or the second area.

6. The vehicle of claim 2, the processor further configured to:
in response to detecting a second vehicle in a first blind spot corresponding to a first side of the vehicle, visually distinguish the second input feed of the second camera corresponding to the first side-view camera; and
in response to detecting the second vehicle in a second blind spot corresponding to a second side of the vehicle, visually distinguish the third input feed of the third camera corresponding to the second side-view camera.

7. The vehicle of claim 1, the processor further configured to:
zoom in or out at least one of the input feeds to display in a corresponding display area.

8. The vehicle of claim 1, the processor further configured to:
pan at least one of the input feeds to display in a corresponding display area.

9. The vehicle of claim 1, wherein the display comprises a rear-view mirror replacement display.

10. A vehicle comprising:
a plurality of cameras;
a display; and
a processor coupled to the plurality of cameras and the display, the processor configured to:
in a first state, display, on the display, a first feed based on one or more first cameras of the plurality of cameras; and
in a second state, display, on the display, a second feed based on one or more second cameras of the plurality of cameras;
wherein a first allocation of display area to the one or more first cameras is different than a second allocation of the display area to the one or more second cameras.

11. The vehicle of claim 10, wherein the first state comprises an autonomous driving state and the first feed comprises an input feed from one rear-view camera; and wherein the second state comprises a non-autonomous driving state and the second feed comprises input feeds from the one rear-view camera and at least one side-view camera.

12. The vehicle of claim 10, wherein the first state comprises a blind spot empty state and the first feed comprises an input feed from one rear-view camera; and wherein the second state comprises a blind spot occupied state and the second feed comprises input feeds from the one rear-view camera and at least one side-view camera.

13. The vehicle of claim 10, wherein the first state comprises a blind spot empty state and the first feed comprises input feeds from one rear-view camera and two side-view cameras; wherein the second state comprises a blind spot occupied state and the second feed comprises input feeds from the one rear-view camera and the two side-view camera; wherein at least one side-view camera is allocated a larger percentage of display area in the second state than is allocated to the at least one side-view camera in the first state.

14. The vehicle of claim 10, wherein the first state comprises a turn indicator deactivated state and the first feed comprises an input feed from one rear-view camera; and wherein the second state comprises a turn indicator activated state and the second feed comprises input feeds from the one rear-view camera and one side-view camera corresponding to a side indicated by the turn indicator.

15. The vehicle of claim 10, wherein the first state comprises a turn indicator deactivated state and the first feed comprises input feeds from one rear-view camera and two side-view cameras; wherein the second state comprises a turn signal activated state and the second feed comprises input feeds from the one rear-view camera and the two side-view camera; wherein at least one side-view camera is allocated a larger percentage of display area in the second state than is allocated to the at least one side-view camera in the first state.

16. The vehicle of claim 10, wherein the first state comprises a forward drive state and the first feed comprises input feeds from one rear-view camera and two side-view cameras; wherein the second state comprises a reverse drive state and the second feed comprises input feeds from the one rear-view camera and the two side-view camera, wherein the at least one input feed from one of the two side-view cameras is zoomed in and panned down in the second state as compared with the first state.

17. The vehicle of claim 10, wherein the first state comprises a low-speed state and the first feed comprises an input feed from at least one rear-view camera; wherein the second state comprises a high-speed state and the second feed comprises an input feed from the one rear-view camera, wherein the input feed from the at least one rear-view cameras is zoomed in in the first state as compared with the second state.

18. A method comprising:
receiving input feeds from the plurality of cameras; and
displaying, on a display in a vehicle interior of a vehicle, a composite feed based on the input feeds;
wherein a first area of the display is allocated to a first input feed of a first camera of the plurality of cameras, a second area of the display is allocated to a second input feed of a second camera of the plurality of cameras, and a third area of the display is allocated to a third input feed of a third camera of the plurality of cameras;
wherein the first area is different than the second area or the third area.

19. The method of claim 18 further comprising:
in response to detecting a second vehicle in a first blind spot corresponding to a first side of the vehicle:
increase the second area allocated to the second input feed of the second camera, and
decrease at least one of the first area or the third area; and
in response to detecting the second vehicle in a second blind spot corresponding to a second side of the vehicle:
increase the third area allocated to the third input feed of the third camera, and decrease at least one of the first area or the second area.

20. The method of claim 18 further comprising:
in response to detecting an activation of a turn signal corresponding to a first side of the vehicle:
increase the second area allocated to the second input feed of the second camera, and
decrease at least one of the first area or the third area; and
in response to detecting an activation of the turn signal corresponding to a second side of the vehicle:
increase the third area allocated to the third input feed of the third camera, and
decrease at least one of the first area or the second area.
